(19) United States
(12) Patent Application Publication
(10) Pub. No.: US 2011/0022298 A1
(43) Pub. Date: Jan. 27, 2011

(54) METHOD AND SYSTEM FOR MODIFYING A DRIVE PLAN OF A VEHICLE TOWARDS A DESTINATION

(75) Inventor: Peter Kronberg, Vastra Frolunda (SE)

Correspondence Address: WRB-IP LLP, 801 N. Pitt Street, Suite 123, ALEXANDRIA, VA, 22314, US

(73) Assignee: Volvo Technology Corporation, Goteborg (SE)

(21) Appl. No.: 12/933,446

(22) PCT Filed: Apr. 11, 2008
(86) PCT No.: PCT/SE2008/000269

§ 371 Date: Sep. 20, 2010

(51) Int. Cl. G01C 21/34; B60K 28/06

(52) U.S. Cl. 701/200

(57) ABSTRACT

A method and system for modifying a drive plan, especially a drive/rest schedule of such a plan, of a vehicle before and/or during a drive towards a desired destination is provided in which (a) a development of the alertness level of a driver is predicted, (b) points in time are determined and classified as high risk instances, where the predicted development becomes equal to or smaller than a predetermined threshold level, (c) the high risk instances are compared with the drive plan or drive/rest schedule and it is determined whether any high risk instance will occur before the destination or a next planned stop or rest is reached and (d1) if a high risk instance is determined to occur before the destination or the next planned stop or rest is reached, a modified drive plan or drive/rest schedule is calculated such that a stop or rest will occur before or at the next high risk instance.

### BACKGROUND AND SUMMARY

The invention relates to a method and system for modifying a drive plan, especially a drive/rest schedule of such a drive plan, of a vehicle before and/or during a drive towards a desired destination.

Planning a drive and finding timely and safe places to stop and rest can be an expensive work especially for commercial drivers because on the one hand ontime deliveries are demanded and on the other hand prescribed drive/rest schedules and other driving safely issues are to be considered. This problem is in particular recognized by drivers who drive outside the borders of their own country. The problem of finding safe places to stop is particularly significant in order to avoid that truck drivers stop in less than optimal locations due to the fact that they are forced by law or by their individual lack of alertness due to e.g. an impairment like sleepiness, to stop but are unable to find a convenient or safe place to stop.

In recent years numerous in-vehicle countermeasures for dealing with sleepiness in driving have been developed. The related research and development activities have advanced the state of the art of sensors and technologies as well as increased the understanding of sleepiness and driving. In many cases, however, the technical issues associated with the real-life operation of such monitoring devices are overwhelming, resulting in poorly performing systems.

It is desirable to provide a method and a system for modifying a drive plan, especially a drive/rest schedule of such a plan, of at least one vehicle towards a desired destination under consideration of an individual development of a level of a state of the driver of the vehicle, like especially the level of alertness or impairment of the driver such that safety of the drive is not substantially affected.

It is also desirable to provide a method and a system for modifying a drive plan, especially a drive/rest schedule of such a plan, in such a way that it can be flexibly adapted to a change of a present and/or future said level of a driver state.

The method according to an aspect of the invention for modifying a drive plan, especially a drive/rest schedule of such a plan, of a vehicle before and/or during a drive towards a desired destination, comprises the following steps:

(a) predicting a development of a level of a state of the driver of the vehicle or updating a previous such prediction, by means of at least one of a driver state monitoring device, a known mathematical, a known statistical and a known rule-based model of a state of a human being, on the basis of predetermined environment variables and data about a physical condition or impairment of the driver and storing the predicted development in a storage;

(b) determining points in time, where the predicted development of the level of the driver state becomes equal to or smaller than a predetermined threshold level and classifying or annotating these points in time as high risk instances;

(c) comparing the high risk instances with the drive plan or drive/rest schedule and determining whether any high risk instance will occur before the destination or a next planned stop or rest is reached; and (d1) if a high risk instance will occur before the destination or the next planned stop or rest is reached, calculating a modified drive plan or drive/rest schedule such that a stop or rest will occur before or at the next high risk instance.

An aspect of the invention is advantageously applicable for managing the drive of one or more trucks or buses or other (commercial) vehicles which are traveling over a long distance, in order to avoid accidents which are caused at least partly by a reduced alertness due to e.g. fatigue or drowsiness or another impaired state of the driver(s) of such vehicle(s).

By means of an aspect of the invention, the drive to a desired destination can be managed in such a way that the vehicle reaches the desired destination not only within a desired time period but also under consideration of regulations regarding prescribed drive/rest schedules and/or speed limits and/or the actual state of the driver or his ability to drive the vehicle in a safe manner.

### BRIEF DESCRIPTION OF THE DRAWINGS

Further details, features and advantages of the invention will become apparent from the following description of exemplary and preferred embodiments of the invention in connection with the drawings, in which shows:

FIG. 1 a flow chart of a first embodiment of a method according to an aspect of the invention conducted for establishing or preparing a drive of a vehicle;

FIG. 2 a flow chart of a second embodiment of a method according to an aspect of the invention conducted for establishing or preparing a drive of a vehicle;

FIG. 3 a flow chart of a third embodiment of a method according to an aspect of the invention conducted during a drive of a vehicle;

FIG. 4 a flow chart of a fourth embodiment of a method according to an aspect of the invention conducted during a drive of a vehicle;

FIG. 5 a schematic graph of a development of an estimated alertness over time; and

FIG. 6 a schematic block diagram of a system according to an aspect of the invention.

### DETAILED DESCRIPTION

Generally, the method and system according to an aspect of the invention are provided for establishing or planning the drive of a vehicle and/or for adapting such a planning during the drive of a vehicle towards a desired destination in such a way that an information about a predicted development of a level of a state of the driver (wherein the development especially begins at the present time and extends into the future), is used to plan or optimize the drive.

The state of the driver is especially an alertness or a drowsiness or another impairment of the driver. The optimization is especially conducted with respect to points in time when the driver is supposed to rest and when the driver is supposed to drive, and concrete suggestions are provided to the driver for appropriate stops, a route selection and generally on how to plan the drive such that driving occurs when alertness is high and resting occurs when there is a greater risk of a reduced alertness level, especially under consideration of a desired time of arrival at a destination and/or regulations regarding e.g. prescribed drive/rest schedules and/or speed limits and the like.

Preferably, the prediction of the development of the level of the driver state (which is especially a level of alertness) is/are repeatedly updated during the drive with time intervals which are predetermined and/or determined by certain events during the drive like e.g. an actually reduced level of the driver state which occurs during the drive and has not been predicted, however, which is detected by means of a driver state monitoring device. In the latter case, not only the initiation of the conduction of the method, but as well the repetition frequency of these conductions can be determined by such an event. If e.g. a considerably decreased present level of alertness of the driver is detected by the driver state monitoring device, the repetition frequency can be appropriately increased, and vice versa.

If the driver has a prescribed drive/rest schedule (like e.g. a commercial driver) and a pre-determined destination, the system can automatically adapt this schedule based on the predictions of the development of the level of the driver state made by the system, and make sure that the drive/rest schedule or possible other constraints like e.g. delivery times and speed limits are kept at least as far as possible.

Furthermore, the above driver states can be provided to a third party such as a fleet operator, so that he can consider the state of one or more drivers for his fleet management, i.e. for planning the drive of other vehicles of a fleet of vehicles.

The prediction of the development of a driver state can be conducted by means of at least one of a known mathematical, statistical and a rule-based model as exemplarily mentioned below.

If the vehicle is equipped with a driver state monitoring device, this prediction can be improved by also using information about the present objectively measured driver state (especially a level of alertness, drowsiness and/or another impairment level) as performed by the driver state monitoring device. Conversely, the measurements made by the driver state monitoring device can be improved by the predictions made by at least one of the models below.

Both these possibilities are also valid for so called active safety systems which are used to deal with driver impairment like specifically distraction and drowsiness. These known systems typically use sensors which monitor the driver or the driving behavior of the driver in order to detect drowsiness (or distraction or any other impairment).

Apart from the above driver states, the planning or optimization of the drive plan (especially of a drive/rest schedule) can be conducted by using background and context information like e.g. information provided by a navigation system, such as map and route plan, or information about e.g. desired deadlines and given destinations of the drive as provided by e.g. a fleet management system, or information about a demanded drive/rest schedule, etc., depending on what of this information is available to the system. Consequently, such information is used as per availability, but is not necessary for the basic functionality of the methods according to the invention. The information can be used for making the system according to the invention more sophisticated, and if it is available the content of the information can be adapted to account for a measured present and for a predicted development of a level of a driver state.

For example, a navigation system can be used to automatically find and suggest real (safe) places for the driver to stop if he cannot reach the destination or a next planned stop or rest before a level of his state falls below a predetermined threshold, and even provide route guidance for the driver to these places. Furthermore, information about the planned drive such as predetermined destinations, planned total duration of the drive and planned total distance to drive to the desired destination can be considered.

Furthermore, numerous other in-vehicle systems or driving support devices like e.g. route planning devices, drive scheduling devices, drive/rest scheduling devices, or fleet management devices and others exist that support the driver in keeping track of the drive/rest schedule as well as assist the driver when navigating, and which systems and devices can be applied or used together with the method and system according to the invention.

More in detail, information about the development of the level of at least one of the above driver states is for example used to adapt the content and/or the output of one or more of such driving support devices in such a way that the established route is optimized with respect to the planning of stops and/or the selection of a course during the route, so that a desired or predetermined time of arrival at a desired destination can be kept. This adaptation is preferably presented to the driver in the form of an information on a display regarding a suggestion on how to change the established route, e.g. to make a stop at a certain place which is recommended by the driving support device on the basis of e.g. a navigation system including a database of stops which are appropriate for the related vehicle or truck along the route or an alternative segment of the route.

Consequently, the system according to the invention acts to the driver as an expert system by providing timely information and suggestions that help the driver planning, adapting and optimizing the drive plan, especially a drive/rest schedule, if the driver cannot reach the destination or a next planned stop or rest before a level of his state falls below a predetermined threshold, so that the risk of succumbing to drowsiness is minimized or, at least, reduced.

Summarizing the above, a driver of a vehicle is provided with a system, which can assist the driver in the planning, conducting and/or adapting the drive to the destination. This is achieved e.g. by integrating a route planning/fleet management system (which is common in foremost commercial transport operations) of the vehicle with a predictive model especially of alertness or sleepiness into an expert system which dynamically modifies the scheduling of the drive by suggesting an optimal drive schedule and appropriate (i.e. safe and timely) places to make stops, with the aim to minimize or, at least, to reduce the risk of the driver succumbing to a lack of alertness (e.g. sleepiness) or other impairment of his ability to drive the vehicle in a safe and correct manner.

The system also uses the predictions made to inform the driver (and/or third party) about elevated risks of drowsiness or other driver impairment. This information can be presented to the driver (and/or a third party) before the start of the drive if the system predicts that the driver is likely to become drowsy or otherwise impaired during the drive. Moreover, predictions about future risks for becoming drowsy can be presented at any time during the drive.

One basic concept of the method and system according to the invention is to integrate e.g. a mathematical model of alertness (an example of such a model is Folkard & Akerstedt's “A three-process model of the regulation of alertness sleepiness”, in R. J. Broughton & R. D. Ogilvie (Eds.): Sleep, Arousal and Performance (pp. 13-26), Boston: Birkhauser, 1992) with a fleet management-, navigation-, drive-rest scheduling and route planning systems of a vehicle in order to optimize the drive, especially the scheduling and planning of the drive. This model also includes estimating a present level of alertness of a driver. However, other known models of alertness can be applied as well.

This entails suggesting the timing and location of (safe) stops (through the use of global positioning information and a navigation system) in a manner that assists the driver to plan the drive so that he/she drives when the alertness level is high, and rests when the alertness level is low, while accounting for the external demands imposed by delivery times, speed limits, prescribed resting times and others. When the driver initiates unscheduled stops the method and system according to an aspect of the invention can dynamically modify the drive/rest schedule and the route planning.

This basic concept can be optionally extended by adding objective drowsiness measurements recorded by a real-time driver state or drowsiness monitoring device as a means to refine the prediction and monitor the continuous state of the driver. Moreover, also the detection performed by the driver state or drowsiness monitoring device may be improved upon by taking into account the likelihood of the driver being drowsy as estimated by a model of drowsiness.

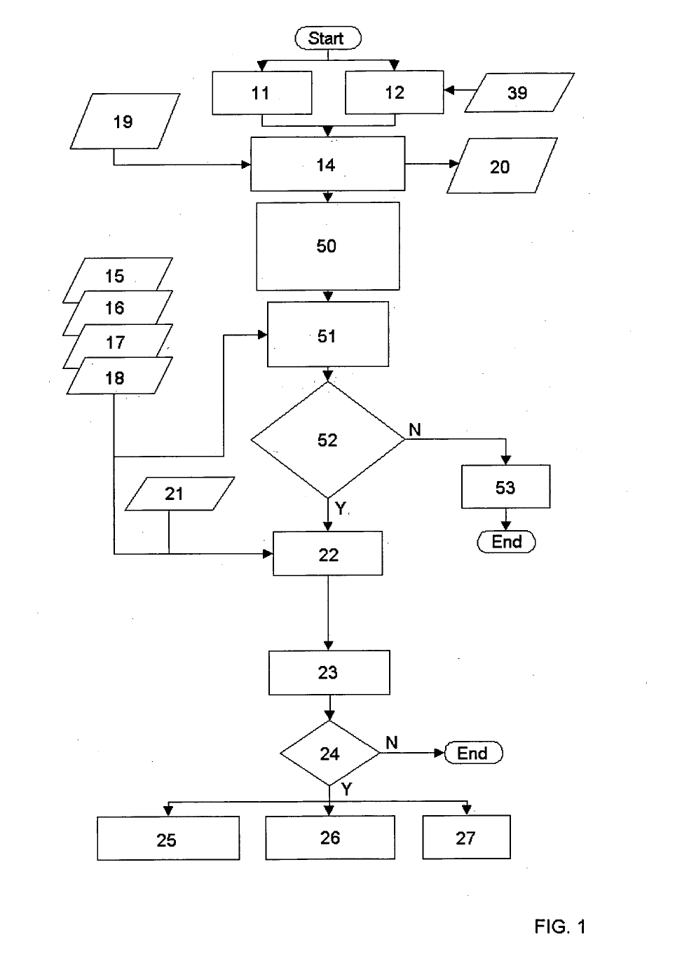

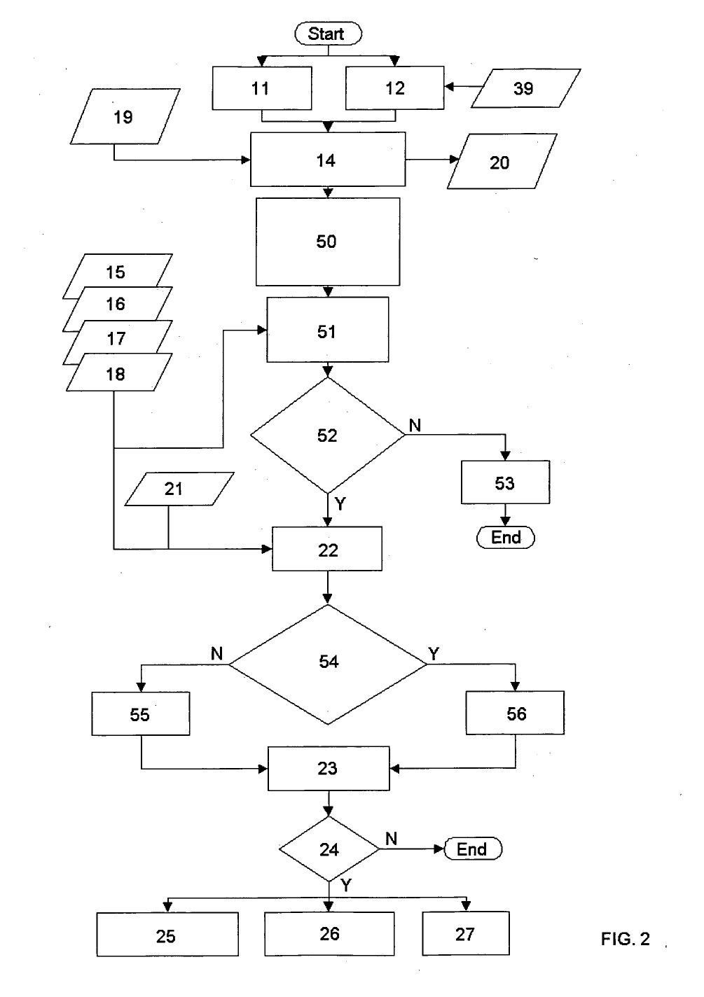

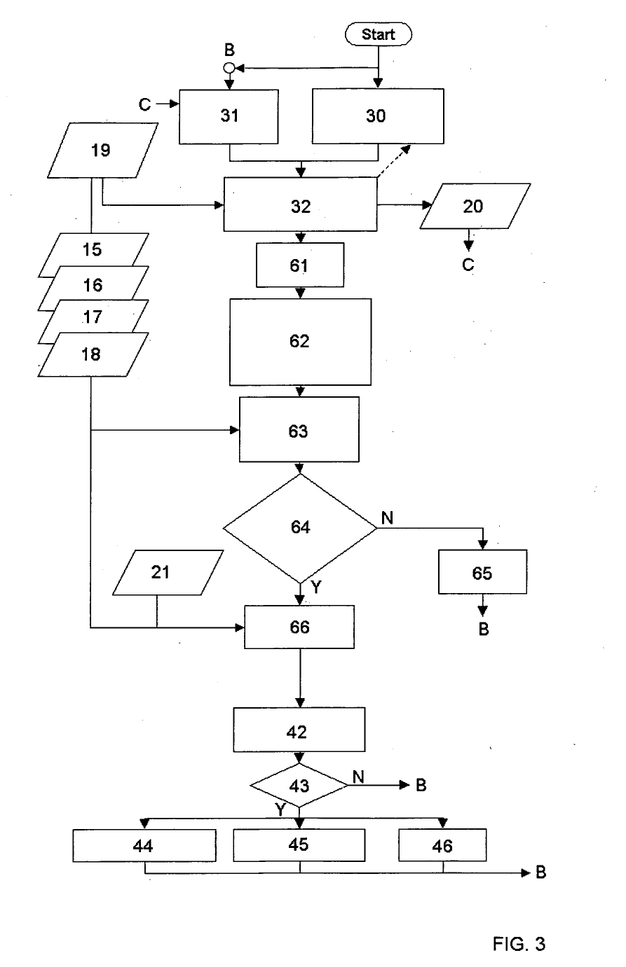

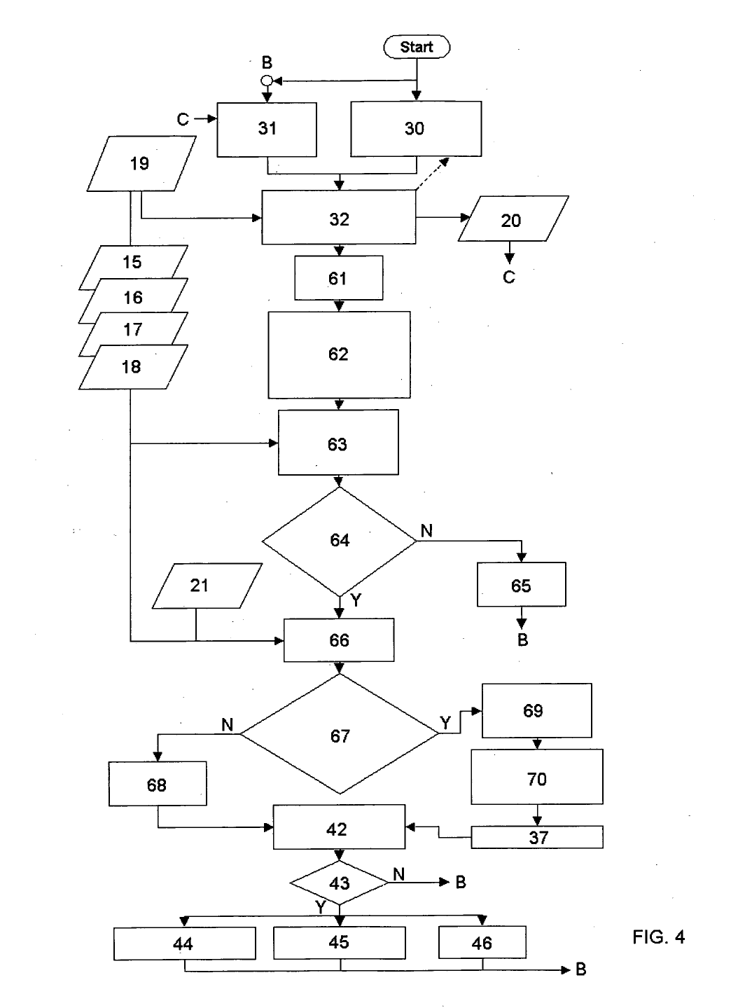

In the following, a first to fourth exemplary embodiment of the method according to an aspect of the invention is described with reference to FIGS. 1 to 4. One of the first and second embodiment as shown in FIGS. 1 and 2, respectively, is conducted for initiating, preparing or planning a drive of a vehicle before the drive is started. One of the third and fourth embodiment as shown in FIGS. 3 and 4, respectively, is conducted during the drive of a vehicle. The first and the second embodiment can be combined with the third or fourth embodiment, so that one of the first and the second embodiment is conducted for planning or initiating a drive and one of the third and fourth embodiment is conducted subsequently during the drive of the vehicle to the desired destination. The methods according to FIGS. 1 to 4 can be amended by additional steps, if necessary, on the basis of the above and the following disclosure.

The method according to the first embodiment as shown in FIG. 1 is conducted as follows. When a driver has entered his vehicle the method is started and the driver inputs in a first step 11 his personal data by means of e.g. a driver ID card into the system. Furthermore, the driver is requested by the system to input further data which are relevant for predicting the development of the level of a driver state, in the following embodiments in the form of the level of alertness of the driver, such as data which are related to his physical or health condition like the time of awakening, the duration of sleep during the prior night(s), the sleep quality (any, none, or a quality score between them) and other vital contextual information. Additionally or alternatively, a part or all of these data can be retrieved in an optional second step 12 from a first storage 39 in which the data of the driver have been stored at the time of an earlier conduction of the method by the same driver. Furthermore, by the driver a predetermined drive or route plan of the vehicle towards a desired destination is stored in a second storage 15, and a drive/rest schedule of such a plan is stored in a third storage 16.

On the basis of these data and certain environment variables like for example time of day which are stored in a fourth storage 19, in a third step 14, the system calculates a prediction of the development of the level of alertness of the driver as a function of time as explained above and stores this development in a fifth storage 20.

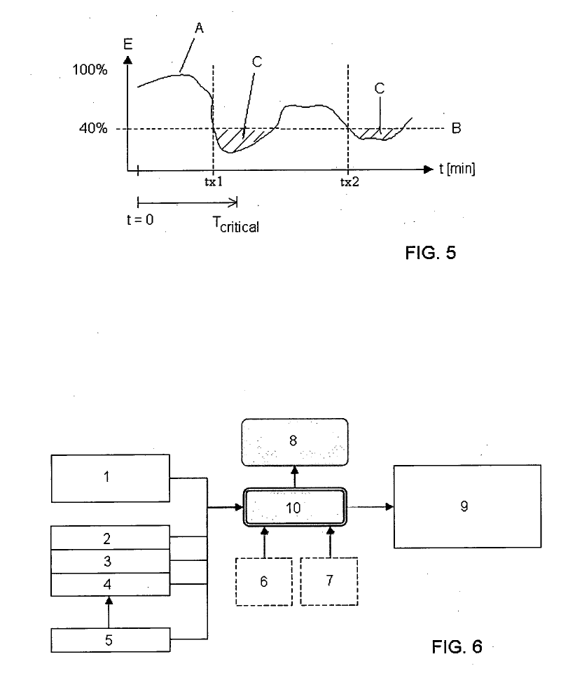

FIG. 5 schematically shows such a curve A of a development of the predicted or estimated alertness level E [%] as a function of time t [min], beginning from the present time at t=0 and extending into the future. The alertness level is exemplarily expressed in percent, wherein 100 percent is assumed to be a maximum possible alertness level and 0 percent is a complete lack or zero alertness level, for example when the driver is sleeping. Furthermore, a dotted horizontal line B in FIG. 5 indicates a preset alertness threshold level, exemplary at 40 percent of the maximum alertness level.

This alertness threshold level B can either be fixedly preset for all drivers or preset individually for a certain driver in dependence for example on his age, experience, health or other conditions. The threshold level B is preset such that if the driver's alertness level is below this threshold level (areas C in FIG. 5) he is assumed to have a level of alertness that is too low for the driver to be considered as a safe driver.

Reverting back to the flowchart of FIG. 1, then in a fourth step 50 it is determined at which point or points in time the predicted alertness level A falls below the alertness threshold level B (see FIG. 5), and these times are annotated as high risk instances tx. In the example of FIG. 5, there are two such instances or times tx1 and tx2 indicated at which the predicted alertness level A falls below the threshold level B.

In a fifth step 51, the high risk instances tx are compared with the planned drive plan or drive/rest schedule. For this purpose, certain data are read out from at least one of a plurality of storages, like e.g. the drive or route plan from the second storage 15, the drive/rest schedule from the third storage 16, GPS data from a sixth storage 17 and data regarding a fleet management system from a seventh storage 18.

On the basis of these data it is determined in a sixth step 52 whether there is any high risk instance tx occurring before the destination or a next planned stop or rest is reached according to the current drive/rest schedule.

If there is no such high risk instance before the estimated time of reaching the destination or the next planned stop, (“N” at the sixth step 52 in FIG. 1), the method is proceeded with a seventh step 53 in which the driver is informed about a currently low or no risk of lack of alertness, and the method is terminated and the driver can start his drive.

However, if it has been determined in the sixth step 52 that a high risk instance tx will occur before the time of reaching the destination or the next planned stop (“Y” at the sixth step 52 in FIG. 1), the method is proceeded with an eighth step 22, in which a modified drive (or route) plan or drive/rest schedule is calculated such that a next planned stop or rest will occur before or at the predicted next high risk instance tx. For this purpose, again, certain data are read out from at least one of a plurality of storages, like e.g. the (prior) drive or route plan from the second storage 15, the (prior) drive/rest schedule from the third storage 16, GPS data from the sixth storage 17 and data regarding a fleet management system from the seventh storage 18. Furthermore, optimization rules for calculating such a modified drive plan or drive/rest schedule can be read out from an eighth storage 21.

Thereafter, in a ninth step 23 the driver is informed about the proposed modifications of the drive plan/rest schedule, and the driver is requested in a tenth step 24 to confirm these modifications.

If the driver confirms the modifications (“Y” at the tenth step 24 in FIG. 1), accordingly updated data are sent according to an eleventh step 25 to the second storage 15 comprising the drive or route plan and the third storage 16 comprising the drive/rest schedule, according to a 12th step 26 to the sixth storage 17 comprising the GPS data and according to a 13th step 27 to the seventh storage 18 comprising the data regarding the fleet management system. Furthermore, other persons involved (as the fleet operator or the addressee at the final destination of the drive) can be accordingly informed as well. Then the method is terminated and the driver can start the drive.

If according to the tenth step 24 the driver does not confirm the modifications (“N” at the tenth step 24 in FIG. 1), the method is terminated without conducting the above steps 25 to 27, but the driver can nevertheless start his drive.

FIG. 2 shows a second embodiment of the method according to an aspect of the invention which again is conducted for initiating, preparing or planning a drive of a vehicle before the drive is started.

The steps which have been described above with reference to the first embodiment as shown in FIG. 1 are as well conducted in this second embodiment, however, the second embodiment is amended by additional steps in order to make a more detailed evaluation of the risk that the driver has a too low level of alertness that is too low for the driver to be considered as a safe driver.

As can be seen by a comparison of the flowcharts of FIGS. 1 and 2, these additional steps are inserted between the eighth step 22 and the ninth step 23 whereas the other steps remain unchanged. Consequently, only the additional steps shall be described in the following, and with regard to the other steps, reference is made to FIG. 1 and the related explanations above.

In this second embodiment, in addition to the evaluation of a “low or no risk” according to the seventh step 53, a distinction is made between a “medium risk” and a “high risk” at those time instances tx at which the predicted alertness level (curve A in FIG. 5) falls below the alertness threshold level (curve B). By this, especially a rapidly decreasing level of alertness can be captured. For this purpose, a critical time period (Tcritical) is preset which is indicated in FIG. 5 and which starts from the present time (t=0) at which the method is conducted.

The critical time period (Tcritical) preferably has a constant duration which is preset as a fixed or constant value for all drivers, e.g. 5 minutes.

The determination of the critical time period (Tcritical) is based on two considerations. On the one hand, even if the development of the level of alertness is estimated and predicted on the basis of the above models, it cannot be guaranteed that the real level of alertness actually has this level. On the other hand, the alertness level can drop very quickly if for example corresponding stimuli from the environment to the driver which keep a certain level of alertness disappear or are reduced for instance in number or frequency of occurrence, duration and/or intensity, because this will cause the driver to become drowsy very quickly.

Both of these issues make it important to enable the method to be able to determine when the alertness level quickly decreases. Consequently, for all critical time instances tx (at which a predicted alertness level A falls below the alertness threshold level B), it is evaluated, whether this instance tx induces a “high risk” or a “medium risk” of decreased alertness level of the driver. This is realized by determining whether a next critical time instances tx occurs within the critical time period Tcritical (time frame) or not. If it does, it is classified as a “high risk”, and if it doesn't, it is classified as a “medium risk”.

Of course it would be possible at least to some extent to realize a similar functionality by setting the alertness threshold level B appropriately low. If the predicted alertness level A falls below such a lowered threshold level B, a “high risk” would be classified. When the alertness threshold level B is set to a higher value and the predicted alertness level A falls below such a high threshold level B, a “medium risk” would be classified.

Reverting to FIG. 2, after calculating a modified drive plan or drive/rest schedule with the eighth step 22, a 14th step 54 is conducted in which it is determined, whether any of the high risk instances tx occurs before the expiration of the critical time period Tcritical.

If this is not the case (“N” at the 14th step 54 in FIG. 2), then the driver is informed in a 15th step 55, that there is a “medium risk” of reduced alertness, and the method is proceeded with the ninth step 23 as explained above with reference to FIG. 1.

If a high risk instance tx (“Y” at the 14th step 54 in FIG. 2) actually occurs before the expiration of the critical time period Tcritical (this case is indicated in FIG. 5 in form of the risk instance tx1), the driver is informed in a 16th step 56, that there is a “high risk” of reduced alertness, and the method is as well proceeded with the ninth step 23.

FIG. 3 shows a flowchart of a third embodiment of the method according to an aspect of the invention which is conducted during the drive of a vehicle. In the following, it is assumed, that the first or the second embodiment of the method has been conducted before the start of the drive, so that certain data are available for conducting the third embodiment of the method. However, this is not a prerequisite, and if the first or second embodiment is not conducted before, the third embodiment of the method has to be modified accordingly by deleting or modifying the steps related to the first or second embodiment of the method as described below.

The method is started with a first step 30, in which a present level of impairment or drowsiness or alertness of the driver is measured by means of a driver state monitoring device, if such a device is installed in the related vehicle.

If a development of the level of alertness has been predicted during a prior conduction of the method according to one of the first to fourth embodiment, this prior predicted development of the level of alertness is retrieved in a second step 31 from a first storage 20 (arrows C in FIG. 3).

Then, in a third step 32, as a first alternative, an updated development of the level of alertness is predicted on the basis of the retrieved prior predicted such development and, if available, on the basis of the (present) level of impairment measured according to the first step 30, as well as on the basis of the above models of alertness and on the basis of certain inputs made by the driver (as described with reference to the first embodiment of an aspect of the invention above). For this purpose, other data and certain environment variables like for example time of day and the time driven which are stored in a second storage 19, are used as well.

As a second alternative, if there is no prior predicted development of the level of alertness, in the third step 32 the development of the level of alertness is predicted completely new instead of updating it, however, again on the basis of the (present) level of impairment measured according to the first step 30, if available, and on the basis of the above models of alertness and on the basis of certain inputs made by the driver as explained above.

Furthermore, with the third step 32, the predicted (updated or new) development of the level of alertness is stored in the first storage 20 and, if applicable, over-writes the above retrieved (previous) development, so that during the next conduction of the method the new development can be retrieved as indicated with the arrows C.

Finally, with the third step 32, the measurements made by the driver state monitoring device can, as mentioned above, be adjusted or normalized by the predicted (updated or new) development of the level of alertness (if this prediction includes the present time as well). This is indicated by the dotted arrow in FIG. 3.

Then, in a fourth step 61, the development of the level of alertness as predicted for the present time (t=0) (i.e. at the beginning of the development) is displayed to the driver.

Then, in fifth step 62, it is determined at which point or points in time the predicted alertness level A falls below the alertness threshold level B, and these times are annotated as high risk instances tx.

In a sixth step 63, the high risk instances tx are compared with the planned drive plan or drive/rest schedule. For this purpose, certain data are again read out from at least one of a plurality of storages, like e.g. the drive or route plan from a third storage 15, the drive/rest schedule from a fourth storage 16, GPS data from a fifth storage 17 and data regarding a fleet management system from a sixth storage 18.

On the basis of this comparison it is determined in a seventh step 64 whether there is any high risk instance tx occurring before the destination or a next planned stop or rest is reached according to the current drive plan.

If there is no such high risk instance before the estimated time of reaching the destination or the next planned stop (“N” at the seventh step 64 in FIG. 3), the method is proceeded with an eighth step 65 in which the driver is informed about a currently low risk or no risk of lack of alertness, and the method can be repeated via a jump back to point B to the start.

However, if it has determined in the seventh step 64 that a high risk instance tx will occur before the time of reaching the destination or the next planned stop (“Y” at the seventh step 64 in FIG. 3), the method is proceeded with a ninth step 66, in which a modified drive (or route) plan or drive/rest schedule including a next appropriate stopover and other timings is calculated. For this purpose, again, certain data are read out from at least one of a plurality of storages, like e.g. the (prior) drive or route plan from the third storage 15, the (prior) drive/rest schedule from the fourth storage 16, GPS data from the fifth storage 17 and data regarding a fleet management system from the sixth storage 18. Furthermore, optimization rules for calculating such a modified drive plan or drive/rest schedule can be read out from a seventh storage 21.

Thereafter, in a tenth step 42 the driver is informed about the proposed modifications of the drive plan/rest schedule, and the driver is requested in an eleventh step 43 to confirm these modifications.

If the driver confirms the modifications (“Y” at the eleventh step 43 in FIG. 3), accordingly updated data are sent according to a 12th step 44 to the third storage 15 comprising the drive (or route) plan and the fourth storage 16 comprising the drive/rest schedule, according to a 13th step 45 to the fifth storage 17 comprising the GPS data and according to a 14th step 46 to the sixth storage 18 comprising the data regarding the fleet management system. Furthermore, other persons involved (as the fleet operator or the addressee at the final destination of the drive) can be accordingly informed as well. Then the method can be repeated via a jump back to point B to the start.

If the driver does not confirm the modifications as requested in the eleventh step 43 (“N” at the eleventh step 43 in FIG. 3), the method can as well be repeated via a jump back to point B to the start.

FIG. 4 shows a flowchart of a fourth embodiment of the method according to an aspect of the invention which is again provided for being conducted during the drive of a vehicle.

Similarly to the first and second embodiment of the method as described above with reference to FIGS. 1 and 2, the steps which have been described above with reference to the third embodiment as shown in FIG. 3 are as well conducted in this fourth embodiment, and to this extent reference is made to the description of FIG. 3 above. However, the fourth embodiment is amended by additional steps in order to make a more detailed evaluation of the risk that the driver has a level of alertness that is too low for the driver to be considered as a safe driver.

As can be seen by a comparison of the flowcharts of FIGS. 3 and 4, these additional steps are inserted between the ninth step 66 and the tenth step 42 whereas the other steps remain unchanged. Consequently, only the additional steps shall be described in the following, and with regard to the other steps, reference is made to FIG. 3 and the related explanations above.

In this fourth embodiment, in addition to the evaluation of a “low or no risk” according to the eighth step 65, a distinction is made between a “medium risk” and a “high risk” at those time instances tx at which the predicted alertness level (curve A in FIG. 5) falls below the alertness threshold level (curve B in FIG. 5). By this, especially a rapidly decreasing level of alertness can again be captured. For this purpose, again the critical time period (Tcritical) is used which is indicated in FIG. 5 and which starts from the present time (t=0) at which the method is conducted.

The critical time period (Tcritical) preferably has a constant duration which is preset as a fixed or constant value for all drivers, e.g. 5 minutes, and is determined considering the issues as explained above.

According to FIG. 4, after calculating a modified drive plan or drive/rest schedule with the ninth step 66, a 15th step 67 is conducted in which it is determined, whether any of the high risk instances tx occurs before the expiration of the critical time period Tcritical.

If this is not the case (“N” at the 15th step 67 in FIG. 4), then the driver is informed in a 16th step 68, that there is a “medium risk” of reduced alertness, and the method is proceeded with the tenth step 42 as explained above with reference to FIG. 3.

If, however, a high risk instance tx (1T at the 15th step 67 in FIG. 4) actually occurs before the expiration of the critical time period Tcritical (this case is indicated in FIG. 5 in form of the risk instance tx1), in a 17th step 69 a next appropriate stopover is determined. For this purpose, map and route information, navigation data and other information is retrieved from the above mentioned storages 15 to 18 (as described above).

Then the driver is informed in an 18th step 70, that there is a “high risk” of reduced alertness, and the determined route to the next appropriate stopover is presented to him.

Optionally, in a 19th step 37 a cruise control can be turned off. This means that automatic cruise control will be switched off in situations in which a driver is presently deemed to be impaired, in order to reduce the risk of the driver falling asleep with the vehicle is in cruise control mode.

Then the method is proceeded with the tenth step 42 as described above in connection with the third embodiment and FIG. 3.

The method according to the third or fourth embodiment is preferably repeatedly conducted during the drive, so that the prediction of the alertness development is iteratively updated at e.g. 10 Hz, every second, every 5 minutes, or similar, preferably about every 15 minutes. Furthermore, the conduction of the method can be initiated by certain events during the drive like e.g. an actually reduced level of alertness of the driver which occurs during the drive and has not been predicted, however, which is detected by means of a driver state monitoring device.

Generally, the above modification of the drive plan or drive/rest schedule includes at least one of modifying the route, modifying stopovers and modifying other timings, wherein these modifications are calculated on the basis of the data read out from the storages 15 to 19 as explained above and considering the predicted points in time at which the driver is expected to become drowsy or experiences in another way a lack of alertness, so that the driver is driving when alertness is expected to be above the alertness threshold and the driver is resting when the alertness is expected to be below the alertness threshold.

FIG. 6 schematically shows the architecture of a preferred embodiment of a system 10 according to an aspect of the invention, together with certain components and models in the form of their inputs to the system 10 and outputs from the system 10. A driver of the vehicle can generate a first input 1 to the system 10 automatically and/or manually as mentioned above e.g. by means of a driver ID card and/or a manual input. Further inputs are generated by means of the above mathematical models, like e.g. a second input 2 by means of a drive/rest model, a third input 3 by means of a driver behavior model (which may e.g. model when the driver typically schedules his stops when it comes to breaks for lunch) and/or a fourth input 4 by means of the alertness model which has been described in more detail above. Furthermore, a fifth input 5 can be generated by means of context variables, which are as well supplied to the alertness model in order to adapt the fourth input 4.

Furthermore, (optionally) a sixth input 6 can be generated by means of one or more driver state monitoring devices, and (optionally) a seventh input 7 can be generated by means of one or more continuous vehicle data monitoring devices.

The system 10 according to an aspect of the invention generates a first output 8 for operating a human machine interface (“HMI”) like e.g. a display, e.g. in order to provide a feedback to the driver, and a second output 9 for at least one of managing a drive/rest schedule, managing a route planning, proposing safe stopovers, triggering countermeasures, adapting ADAS (“Advanced Driving Assistance System”) and/or IVIS (“In-Vehicle Information System”), informing third persons as for instance an external operator of a fleet management system, etc.

By this integration of inputs 1 to 7 and outputs 8, 9 into the route planning and/or fleet management of the system 10, the driver is enabled on the one hand to better manage the drive, and on the other hand, to optimize the planning of the drive (such as the scheduling of stops) to account for predicted reduced levels of alertness in a way that can be made transparent to the driver due to the HMI output 8. The operator of a fleet management system can as well manage the planning and scheduling of the drive as mentioned above. Furthermore, the fleet operator can make use of information about the alertness/risk of all his drivers at all times.

Furthermore, information may be provided to and for received from the driver both before, during and after the drive in order to allow the driver to better manage his/her drive plan and make sure he/she does not succumb to drowsiness. Vital information that affects how the plan of the drive should be optimized by the system 10 with regards to optimization rules or optimization factors is gathered about: the driver, the driver's sleep history, the constraints imposed on the schedule of the drive, driving environment, etc. These parameters are collectively referred to as the context variables.

The optimization rules or factors above are e.g. determined as: minimizing driving when alertness is low, keeping delivery times, maximizing drive time, keeping drive rest schedule rules, maintaining speed limits on all segments on the planned route, and other.

The context variables above are e.g.:

1.) Map and/or navigation information like e.g. route planning, save or unsafe stops, distances and durations to waypoints, crash statistics for individual road segments, and other;
2.) Static and dynamic constraints like e.g. deadlines, drive/rest schedules, planned stops, and other;
3.) Driver information like e.g. age and gender, and other;
4.) Driver context information like e.g. prior work history, prior sleep, prior sleep quality, time of waking, work shift hours, medication, sicknesses, and other.
5.) Environment variables like e.g. actual time of the day, time of the year, driving time, distance driven, and other.

The system 10 is designed to base its decisions on the information available to it, and does not depend on the availability of any one of the mentioned context variables. More in detail, the above models of alertness can principally make predictions about a future level of alertness independently of an actual state of the individual driver during driving, i.e. without any further input during driving. The performance of these models can of course be improved by additionally considering or using information about a present actual state of the driver during driving. If the actual measured present state requires an earlier rest than estimated by the model, the drive plan should be modified in accordance with the actual measured state. On the other hand, the drive plan should follow the estimation of the model even if the actual state would allow to drive a longer period than predicted by the model in order to make sure that always the safer scenario is taken to calculate the next recommended rest.

In a simple form the likely breaks may be modeled as follows: For a drive taking place at morning to late afternoon, it is expected that the driver at least has three stopovers; breakfast, lunch and afternoon break, where lunch most likely occurs around 11 am-1 pm and is the longest in duration. The system 10 may propose to the driver to change the timing of the breaks individually but most likely not modify the order in which they are taken. If a large dip in alertness is expected e.g. one hour after lunch due to previous food intake followed by a phase of intense digestion or due to the biological clock, the addition of another short break may be proposed to the driver by the system 10 and an appropriate place to stop is suggested and shown in the navigation system.

In addition, the system 10 may use knowledge of the estimated current alertness level and predicted future alertness level of the driver to trigger in-vehicle countermeasures or to adapt vehicle based systems, as for instance ADAS and IVIS-systems to increase safety. This may entail (but is not restricted to) turning off cruise control when the driver is estimated to have reduced alertness.

Generally, it is to be noted that modifications to embodiments of the invention described in the foregoing are possible without departing from the scope of the invention as defined by the accompanying claims.

For example, instead of (or additionally to) drowsiness, other states of the driver (like e.g. an alcohol intoxication or impairment due to medication or sickness) can be measured, estimated and/or predicted with respect to their future development as well and used as described above with respect to drowsiness.

Considering the specific situations, the principles of the invention can as well be used in connection with driving ships, boats or trains or flying airplanes.

Furthermore, expressions such as “including”, “comprising”, “incorporating”, “consisting of, “have”, “is” used to describe and claim the present invention are intended to be construed in a non-exclusive manner, namely allowing for items, components or elements not explicitly described also to be present.

Finally, numerals included within parentheses in the accompanying claims are intended to assist understanding of the claims and should not be construed in any way to limit subject matter claimed by these claims.

1. Method for modifying a drive plan, of a vehicle before and/or during a drive towards a desired destination, comprising:
(a) predicting a development of a level of a state of the driver of the vehicle or updating a previous such prediction, by means of at least one of a driver state monitoring device, a known mathematical, a known statistical and a known rule based model of a state of a human being, on the basis of predetermined environment variables and data about a physical condition or impairment of the driver and storing the predicted development in a storage;
(b) determining points in time, where the predicted development of the level of the driver state becomes equal to or smaller than a predetermined threshold level and classifying or annotating these points in time as high risk instances;
(c) comparing the high risk instances with the drive plan or drive/rest schedule and determining whether any high risk instance will occur before the destination or a next planned stop or rest is reached;
(d1) if a high risk instance will occur before the destination or the next planned stop or rest is reached, calculating a modified drive plan or drive/rest schedule such that a stop or rest will occur before or at the next high risk instance;
(e) determining whether any high risk instance will occur before the expiration of a preset critical time period which starts from the present time at which the method is conducted, and which is preset with respect to its duration for determining a quick decrease of the level of the driver state, and
(f) if a high risk instance will not occur before the expiration of the critical time period re-classifying or re-annotating the high risk instance as a medium risk instance.

2. Method according to claim 1, wherein the driver state is a level of the driver's alertness.

3. Method according to claim 1, comprising:
(f2) informing the driver about a medium risk instance if step (f) reveals that the high risk instance will not occur before the expiration of the critical time period; and
(f3) informing the driver about a high risk instance if step (f) reveals that the high risk instance will occur before the expiration of the critical time period.

4. Method according to claim 1, comprising:
(g) determining a next appropriate stopover of the drive of the vehicle on the basis of map and route information data, if according to step (e) a high risk instance will occur before the expiration of the critical time period.

5. Method according to claim 1, comprising:
(d2) informing the driver about the modified drive plan or drive/rest schedule after the conduction of step (d1) and requesting a confirmation from the driver of the modification; and
(d3) if the driver confirms the modification, storing the modified drive plan or drive/rest schedule in a storage for a next conduction of the method.

6. Method according to claim 1, which is conducted before starting the drive.

7. Method according to claim 1, which is conducted repeatedly during the drive of the vehicle with a predetermined repetition frequency.

8. Method according to claim 1, wherein the conduction and/or the repetition frequency of the conduction of the method is initiated and controlled, respectively, in dependence on an event occurring during the drive which is detected by means of a driver state monitoring device.

9. Method according to claim 1, wherein the modified drive plan or drive/rest schedule is determined on the basis of at least one of a preset drive plan, navigation data and environment variables like the actual time of day, the time driven and the distance driven.

10. Method according to claim 1, wherein the threshold level is a constant preset level, or it can be input by the driver at the start of the method.

11. Method according to claim 1, wherein the critical time period is a constant preset period, or it can be input by the driver at the start of the method.

12. Computer comprising a computer program code for carrying out the steps of the method according to claim 1.

13. Computer program product stored on a tangible computer usable medium, comprising computer program code means adapted to perform the steps of the method according to claim 1 when loaded into the internal memory of a programmable microprocessor means.

14. System for modifying a drive plan, especially a drive/rest schedule of such a plan, of a vehicle before and/or during a drive towards a desired destination, comprising a microprocessor with a computer program for carrying out the steps of the method according to claim 1, a second input for receiving a drive plan including a drive/rest schedule to a desired destination, and at least one of a third input for receiving a driver behavior model, a fourth input for receiving a mathematical, statistical and/or a rule-based model of alertness of the driver, and a sixth input for receiving data from one or more driver state monitoring devices.

15. System according to claim 14, comprising at least one of a first input for receiving input data from a driver, a fifth input for receiving context variables, and a seventh input for receiving data from one or more vehicle monitoring devices.

16. System according to claim 14, comprising at least one of a first output for operating a human machine interface, and a second output for at least one of managing a drive/rest schedule, managing a route planning, proposing safe stopovers, triggering countermeasures and adapting an ADAS (Advanced Driving Assistance System) and/or an IVIS (In-Vehicle Information System).
